(19) United States
(12) Patent Application Publication
(10) Pub. No.: US 2002/0168898 A1
(43) Pub. Date: Nov. 14, 2002

(54) Electrical connector having differential pair terminals with equal length

(76) Inventors: Timothy B. Billman, Dover, PA (US); Andrew C. Cheng, Diamond Bar, CA (US)

Correspondence Address: Wei Te (Joseph) Chung, Foxconn International, Inc., 1650 Memorex Drive, Santa Clara, CA, 95050, US

(21) Appl. No.: 09/852,949

(22) Filed: May 9, 2001

(51) Int. Cl. H01R 13/648

(52) U.S. Cl. 439/608

(57) ABSTRACT

An electrical connector comprises a wafer integrally formed with a pair of terminal pairs and each pair configured by first and second terminals. The first terminal includes a first base portion having a first tail portion, and a first mating portion, the first tail and mating portions extending beyond the wafer. The second terminal includes a second base portion having a second tail portion, and a second mating portion, the second tail and mating portions extending beyond the wafer; wherein the first and second base portions of the first and second terminal are spaced apart from each other in a side-by-side arrangement.

### FIELD OF THE INVENTION

The present invention relates to an electrical connector, and more particular to a very high-density modular connector having a pair of differential pair with equal length, thereby effectively eliminating skew during signal transmission.

### DESCRIPTION OF THE PRIOR ART

High-density electrical connector for use with printed circuit boards has been increasing required by the market in light of the increasing use of the servers, and the storage box.

U.S. Pat. No. 5,993,259 discloses an electrical connector of such application. The connector disclosed in the '259 patent includes a plurality of modularized wafers bounded together. As shown in FIG. 4 of the '259 patent, the terminals are stamped from a metal sheet, then embedded within an insulative material to form the wafer. However, it can be readily seen from FIG. 4 that the length of each terminal is different from its adjacent terminal because of the right-angle arrangement. In addition, it would be unlikely to make two adjacent terminals with equal length. As long as the terminal length is different from one another, skew between terminals is therefore inevitable.

In addition, it will be difficult to have two adjacent terminals to be configured as a differential pair. By the way, because of the shape of the terminals, it is also unlikely to reach equal impedance between two adjacent terminals.

U.S. Pat. No. 6,083,047 discloses an approach to make a high-density connector by introducing the use of printed circuit board. According to teaching of the '047 patent, conductive traces are formed on surfaces of the printed circuit board in a mirror-image arrangement, typically shown in FIG. 12. Again, the conductive traces formed on the surface of the printed circuit board are unlikely to have the same length. Skew is still inevitable.

In addition, in the above-described patent, distance between two adjacent terminals is too close to intercept a ground contact or conductive trace.

In the '259 patent, even a ground bus is provided, however, the ground bus only electrically separate two adjacent wafers, while it can not separate two adjacent terminals.

In the '047 patent, since the conductive traces are exposed on the printed circuit board, arranging a ground bus between two printed circuit boards. According to the teaching of the '047, insulative spacer is arranged to two adjacent printed circuit boards, this will not doubt increase the thickness of the overall dimension of the connector, especially when ground buses are arranged therein.

In addition, when the conductive traces are formed on the printed circuit boards, connecting legs/sockets have to be attached to corresponding conductive trace. This will not doubt complicate the make of the connector.

In the '047 patent, even the conductive traces formed on both sides of the printed circuited board, since the connecting portion and tail portions are soldered thereto, the it will be unlikely to reach equal impedance between two terminals.

### SUMMARY OF THE INVENTION

It is an objective of this invention to provide an electrical connector of high density in which terminal pair within an individual wafer has equal length.

It is still the objective of this invention to provide an electrical connector in which two adjacent wafers are separated by a grounding bus having ground ribs extending two adjacent terminals thereby providing excellent shielding for signal transmission.

In order to achieve the objective set forth, an electrical connector in accordance with the present invention comprises a wafer integrally formed with a pair of terminal pairs and each pair configured by first and second terminals. The first terminal includes a first base portion having a first tail portion, and a first mating portion, the first tail and mating portions extending beyond the wafer. The second terminal includes a second base portion having a second tail portion, and a second mating portion, the second tail and mating portions extending beyond the wafer; wherein the first and second base portions of the first and second terminal are spaced apart from each other in a side-by-side arrangement.

According to another embodiment of the present invention, an electrical connector in accordance with the present invention comprises at least a pair of wafers integrally formed with a plurality of terminals therein, the each wafer defining at least two openings adjacent to a terminal; and a first grounding bus is located between the wafers and forming at least a pair of grounding ribs extending into the openings of the wafer.

### SUMMARY OF THE DRAWINGS

Other objects and further features of the present invention will be apparent from the following detailed description when read in conjunction with the accompanying drawings, in which:

FIG. 1A is an exploded view of a wafer and a grounding bus in accordance with the present invention;

FIG. 1B is a perspective view of an insulative slab of FIG. 1A;

FIG. 1C is a front view of FIG. 1B;

FIG. 1D is a front view of a ground bus of FIG. 1B without grounding ribs removed therefrom;

FIG. 1E is a perspective view FIG. 1E;

FIG. 1F is similar to FIG. 1E and viewed from a reverse direction;

FIG. 1G is similar to FIG. 1D with grounding ribs formed thereon;

FIG. 1H is a front view first group of terminals;

FIG. 1I is a bottom view of FIG. 1H;

FIG. 1J is a front view second group of terminals;

FIG. 1K is a bottom view of FIG. 1J;

FIG. 1L is a front view showing first and second groups of terminals are arranged together without insulative slab enclosed thereon;

FIG. 2 is an assembled view of FIG. 1A;

FIG. 3A is a side view of FIG. 2;

FIG. 3B is a cross sectional view taken along line A-A of FIG. 3A;

FIG. 4A is a perspective view of an electrical connector configured by a plurality of wafers shown in FIG. 2;

FIG. 4B is similar to FIG. 4A viewed from a reverse direction;

FIG. 4C is a side view of FIG. 4A;

FIG. 4D is a cross sectional view taken along line FF-FF of FIG. 4C;

FIG. 4E is a cross sectional view of another embodiment in accordance with the present invention;

FIG. 5A is a perspective view of the electrical connector to be mated with a header;

FIG. 5B is a side view of an electrical connector assembly mounted on printed circuit boards;

FIG. 6A is a perspective view of a connector in accordance with another embodiment of the present invention;

FIG. 6B is a perspective view showing the connector of FIG. 6A is mated with the header shown in FIG. 5A; and

FIG. 6C is a front view of still another embodiment of the present invention.

### DETAILED DESCRIPTION OF PREFERRED EMBODIMENTS

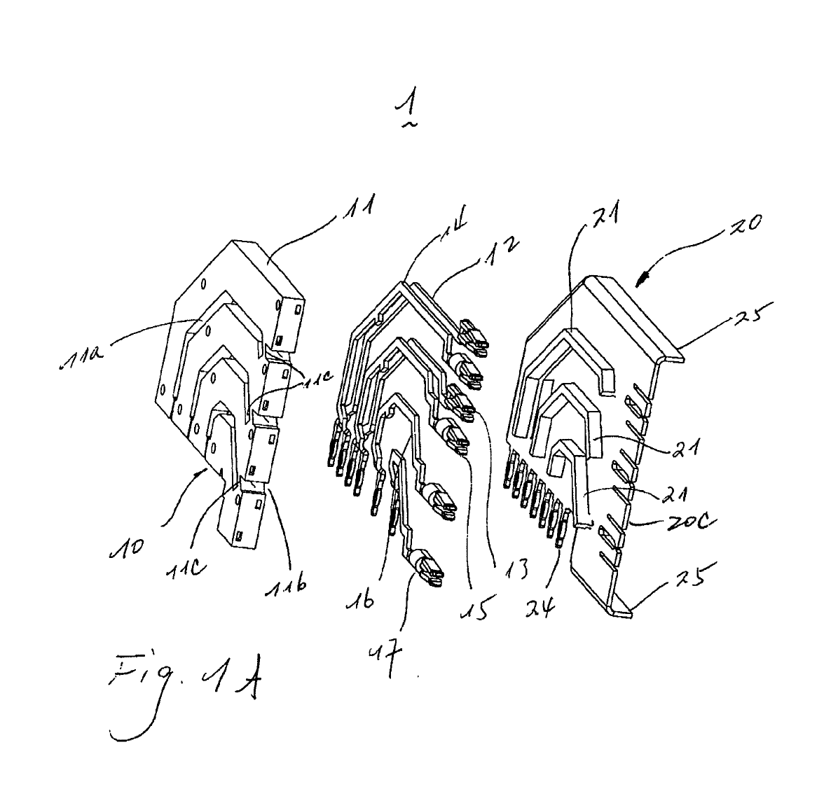

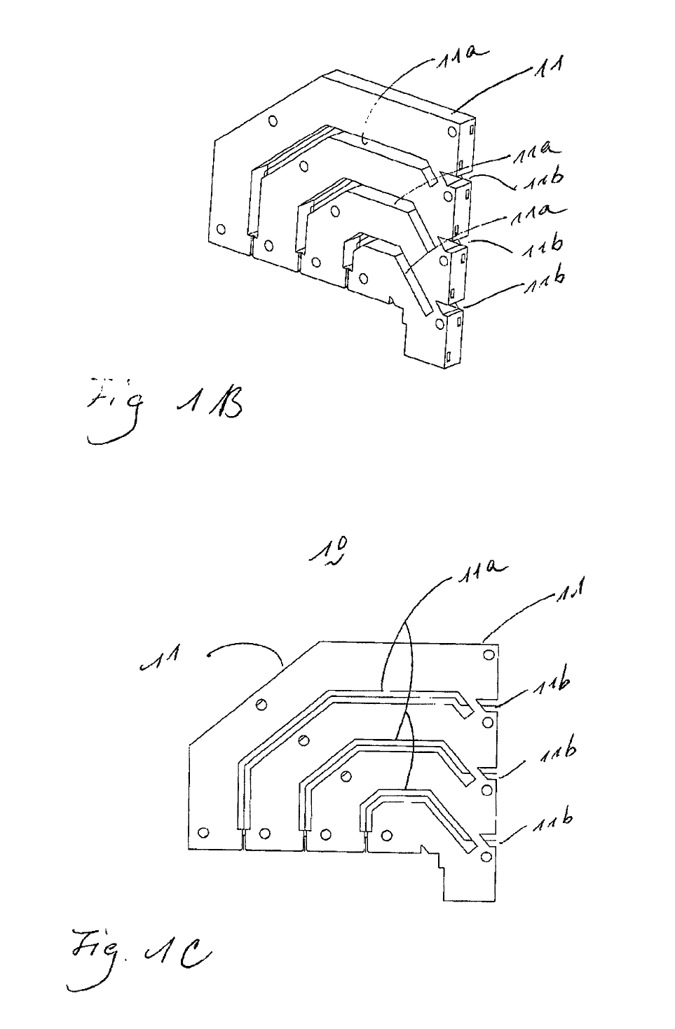

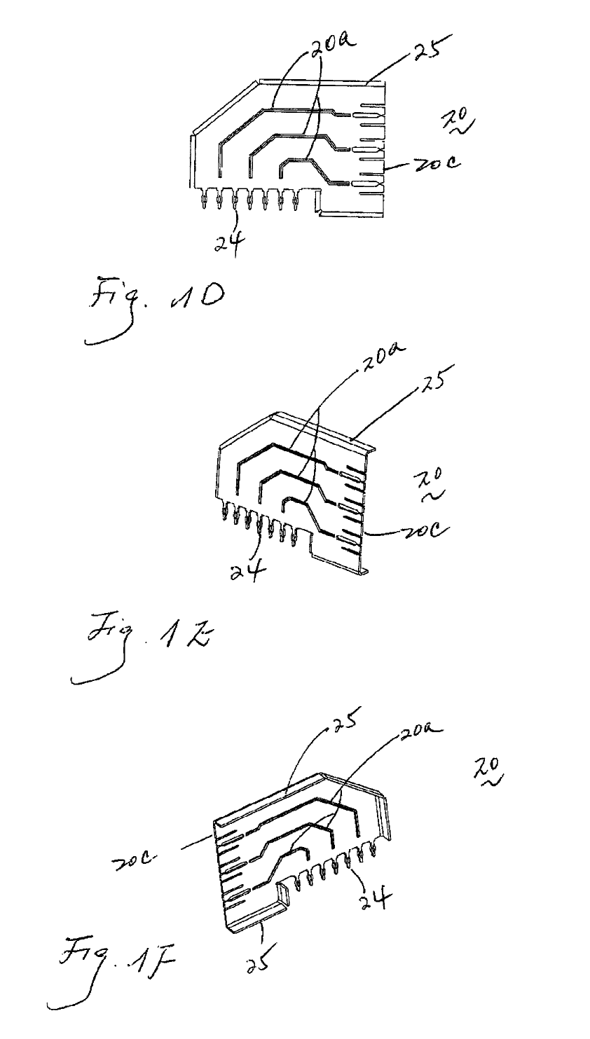

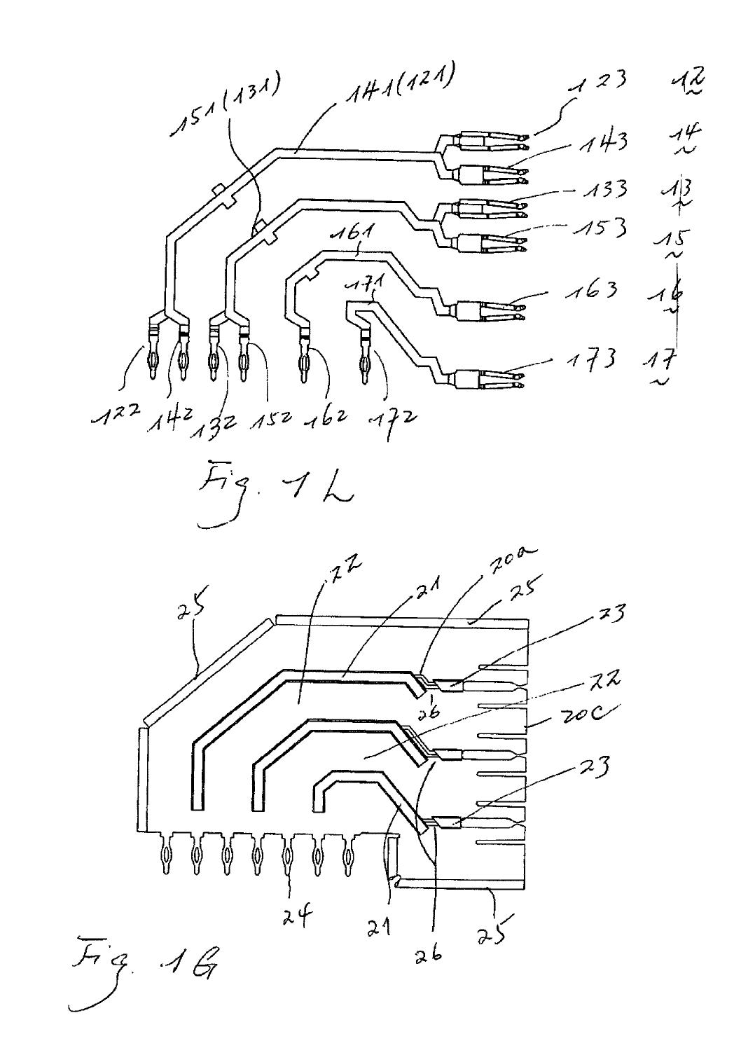

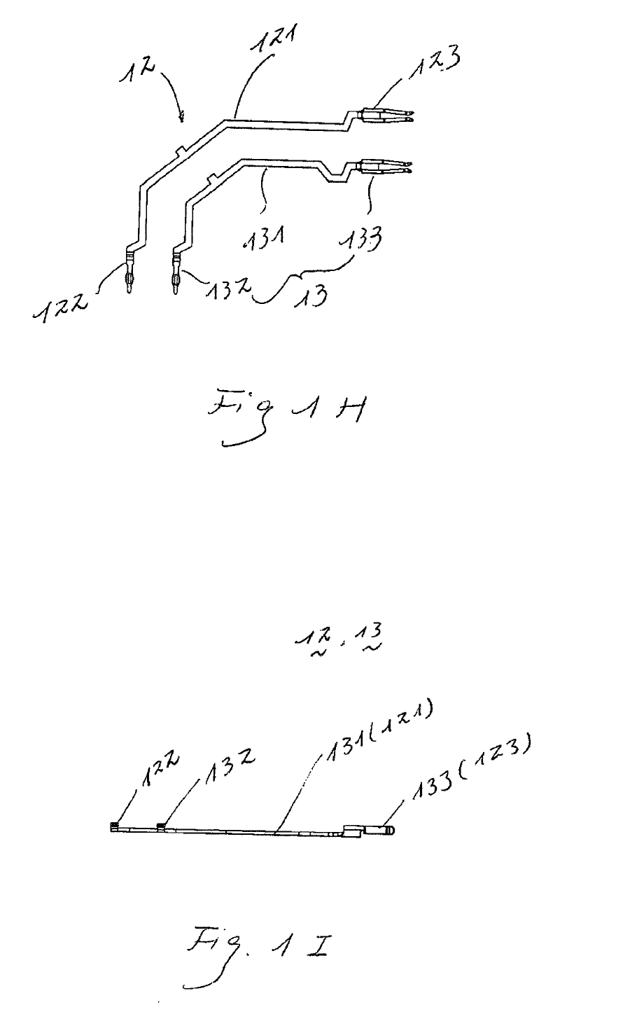

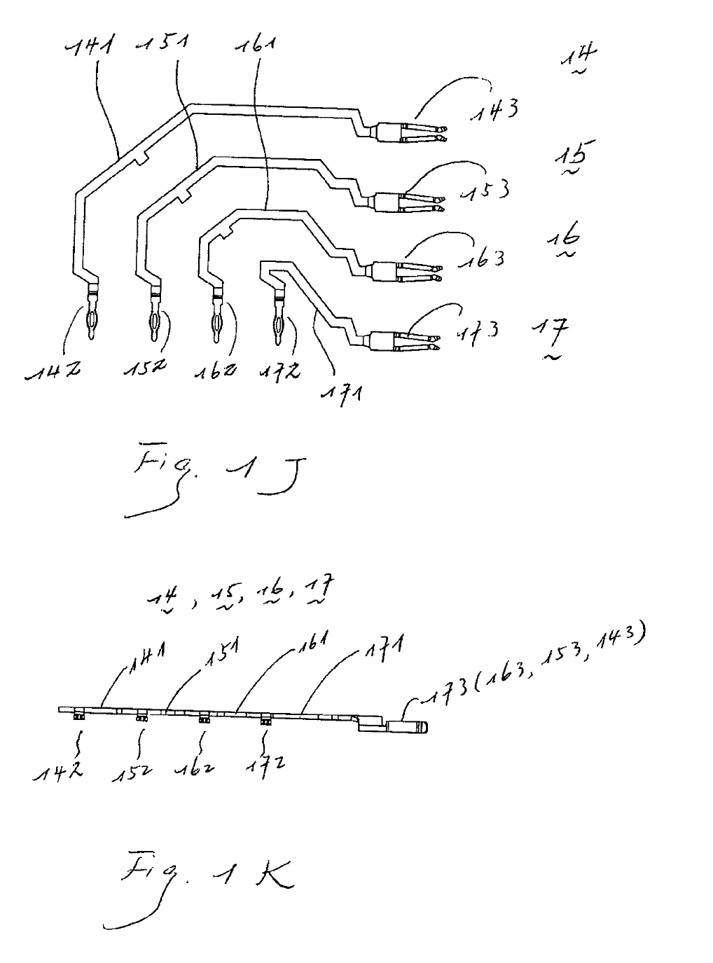

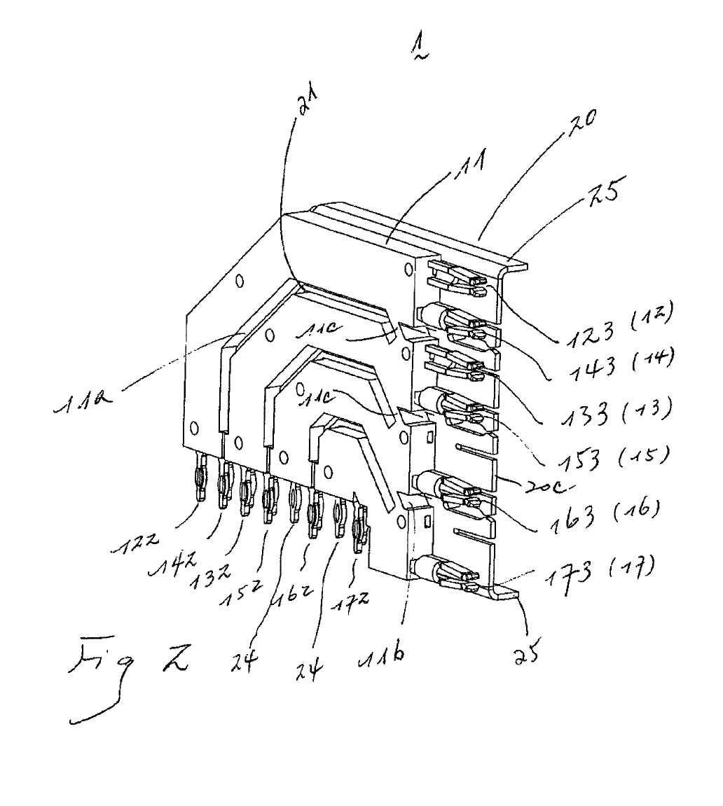

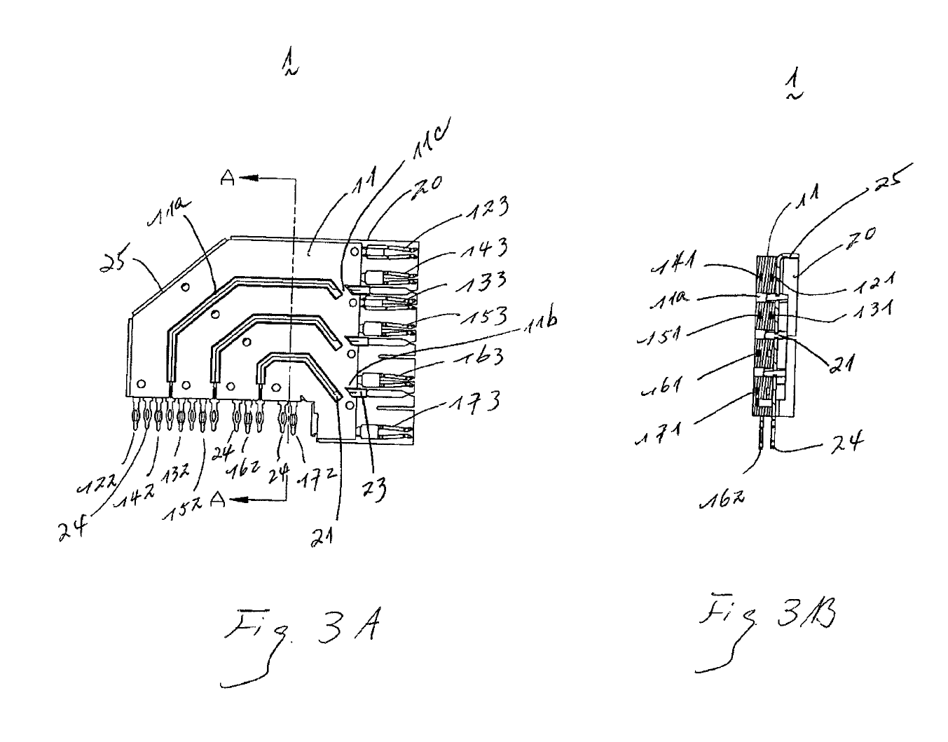

Referring to FIGS. 1A to 1L, 2, 3A and 3B, an electrical connector 1 in accordance with the present invention includes a wafer 10 in accordance with the present invention includes an insulative slab 11 and a plurality of terminals 12, 13, 14, 15, 16 and 17 integrally molded/embedded within the slab 11. A grounding bus 20 is provided and use with the wafer 10 for EMI shielding. When a plurality of wafers 10 is used together, the grounding bus 20 provides necessary shield. The grounding bus 20 includes a plurality of grounding ribs 21 extending therefrom. An electrically shielded passage 22 is defined between two adjacent grounding ribs 21. Detailed description will be given later.

As shown in FIG. 1A, and also FIGS. 1H, 11, and 1J, the terminals 12 and 14 are terminal pairs, while terminals 13, 15 are terminal pair. Since the terminals 12, and 14 are identical except to their length, only one description is given for simplicity. In order to easy description, terminals 12 and 13 are referred to first terminal in the pair, while terminals 14 and 15 are referred to second terminal in the pair.

Each first terminal includes a first base portion 121 (131), a first tail portion 122 (132), and a first mating portion 123 (133). As shown in FIG. 11, the first tail portions 122 (132) are offset upward from the first base portion 121 (131).

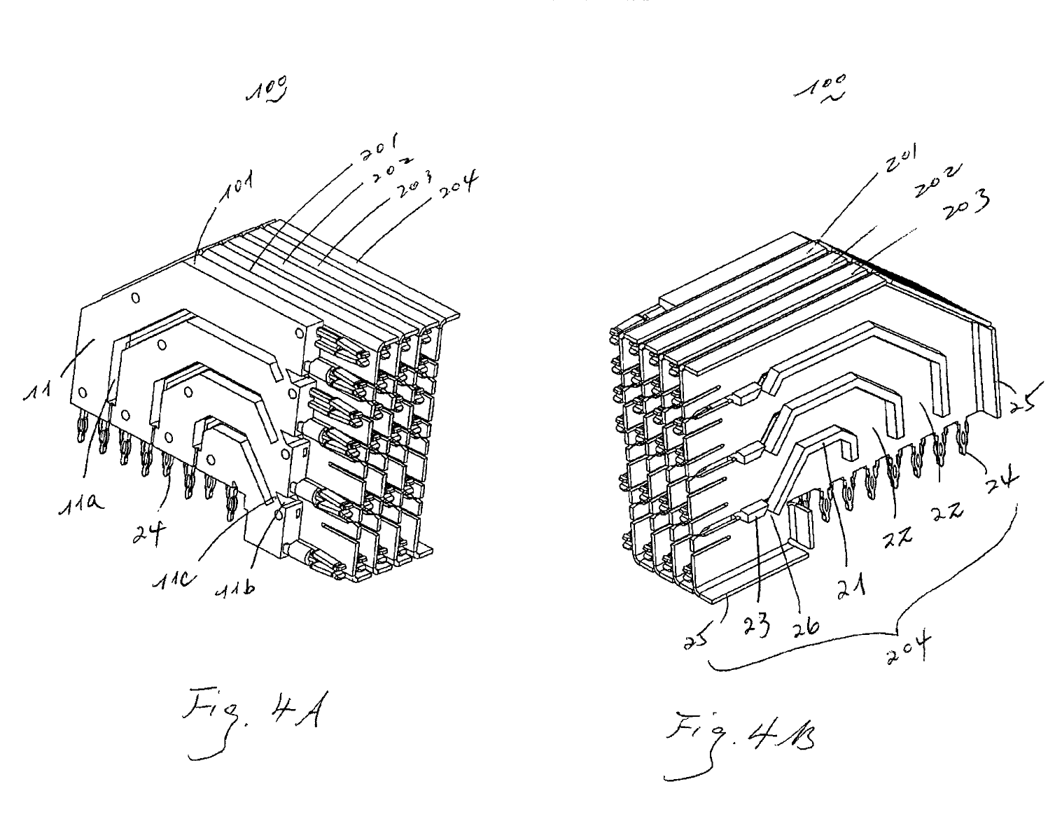

Each second terminal includes a second base portion 141 (151), a second tail portion 142 (152), and a second mating portion 143 (153). As shown in FIG. 1K, the second tail portions 142 (152) are offset downward from the second base portion 141 (151). By this arrangement, when the first and second terminals 12 (13), and 14 (15) are stacked together, the first and second tail portions 122 (132) and 142 (152) are located in the same plane, such as shown in FIGS. 2 and 3B, while the first mating portions 123 (133) and the second mating portions 143 (153) are also located in the same plane.

On the other hand, the first mating portions 123 (133) are offset upward from the base portions 121 (131), while the second mating portions 141 (151) are offset downward from the base portions 141 (151). Again, when the first and second terminals 12 (13), and 14 (15) are stacked together, the sequential order of the mating portions 123 (133), and 143 (153) will become 123, 143, 133, and 153. As a matter of fact, the first and second tail portions 122 (132), and 142 (152) have the same arrangement.

Accordingly, by the offset arrangement of the mating portions 122 (142), and 132 (152), and the tail portions 123 (143), and 133 (153), the terminal 12 has the same length with the terminal 14, while the terminal 13 has the same length with the terminal 15. By this arrangement, the skew between the terminals 12, 14, and 13, 15 are completely eliminated.

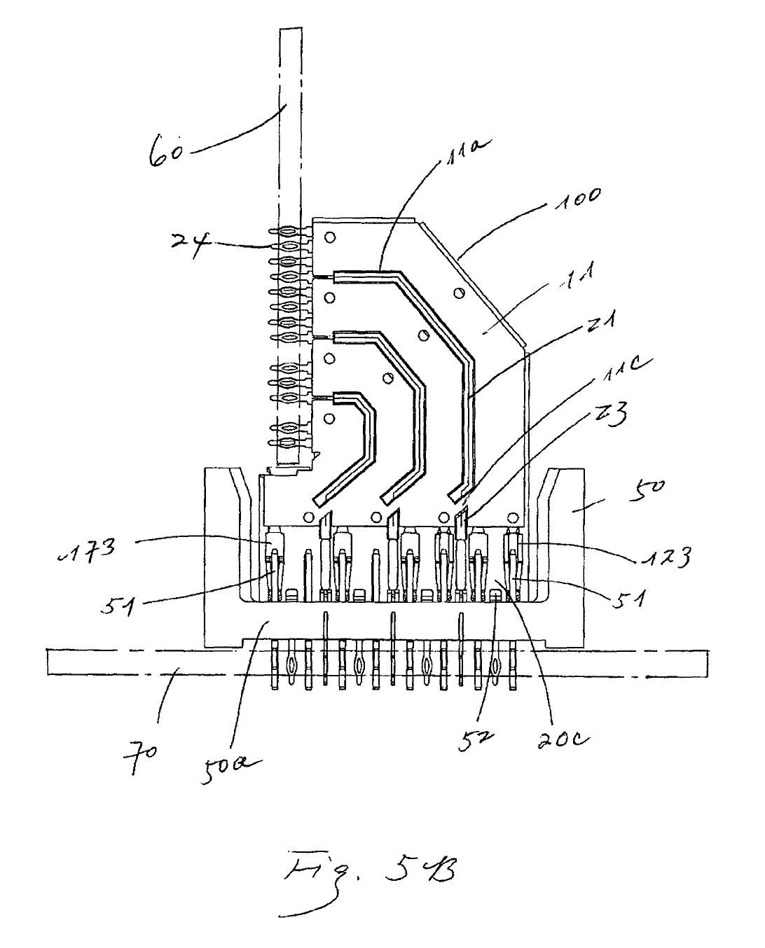

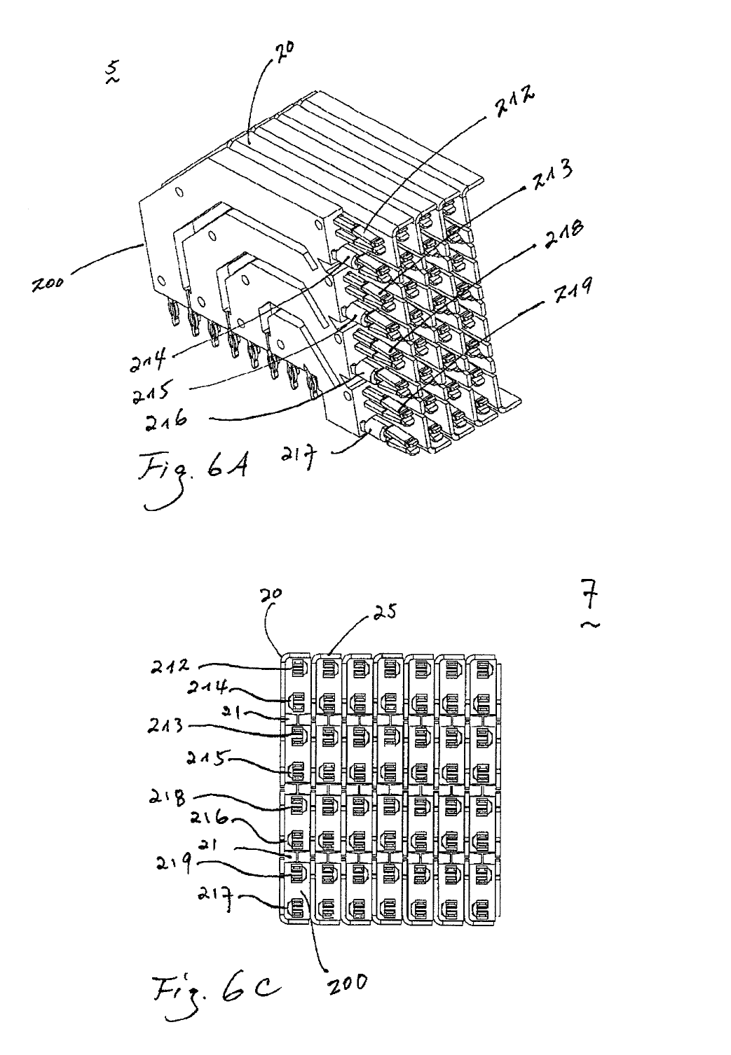

The mating portions 122 (142), 132 (152), 162, and 172 are embodied as a socket to be mated with corresponding headers, FIG. 5A. However, it can be embodied with other configuration.

The plastic slab 11 is generally a plastic material integrally enclosing the terminals 12, 13, 14, 15, 16 and 17. The slab 11 is defined with a plurality of openings 11a which are located between two adjacent terminals 11, 12. The slab 11 is further defined with undercut 11b adjacent to a mating edge 11c thereof. The openings 11a and the undercuts 11b are defined such that bridges 11c are formed therebetween. The bridges 11c formed thereof is use to increase the integrality of the slab 11.

In manufacturing, the first and second group terminals 12, 13, 14, 15, 16, and 17 are stacked together such that the tail portions 122, 142, 132, 152, 162, and 172 are located in the same plane, while the mating portions 123, 143, 133, 153, 163, and 173 are located in the same plane as well. Then the plastic slab 11 is over-molded over those terminals 12, 13, 14, 15, 16, and 17 with the tail portions 122, 142, 132, 152, 162, and 172, the mating portions 123, 143, 133, 153, 163, and 173 extended over the slab 11 for mating with corresponding printed circuit board and headers.

The ground bus 20 is stamped directly from a sheet metal. The grounding bus 20 is directly formed with a plurality of slots 20a corresponding to the contour of the terminals 12, 13, 14, 15, 16, and 17. Each slot 20a is further formed with the grounding ribs 21 through the die-cast molding. Accordingly, when a plurality of ribs 21 is formed, a plurality of passage 22 is also defined between two adjacent ribs 21. The passage 22 is defined corresponding to the terminals 12, 13, 14, 15, 16, and 17. As clearly shown in FIG. 3B, each grounding rib 22 extends into the corresponding opening 11a of the slab 11. Accordingly, the terminals 12, 14 are located within the corresponding passage 22, while the terminals 13, 15 are located in the same passage 22, while the terminals 16 and 17 are located within the corresponding passages 22, respectively. By this arrangement, each terminals or terminal pair are electrically shielded from each other by the passages 22 defined by the grounding bus 20 and corresponding grounding ribs 21.

The grounding bus 20 further defines a plurality of short ribs 23 distant to the grounding ribs 21. As a result, gaps 26 are defined between the grounding ribs 21 and the short ribs 23. The gaps 26 are formed to receive bridges 11c of the slab 11. The short ribs 23 can be readily received in the undercut 11b of the slab 11. By this arrangement, the mating portions (123, 143), (133, 153), 163, and 173 are also electrically separated by the short ribs 23. Accordingly, an excellent shield performance is achieved by the arrangement provided by the present invention.

The grounding bus 20 is further integrally formed with a plurality of grounding legs 24 for mounting to the printed circuit board, such as shown in FIG. 5B. Forming of the grounding legs 24 is only possible by the stamping process. According to the preferred embodiment of the present invention, the grounding legs 24 each has a needle-eye configuration which is electrically connected to a through hole of the printed circuit board once the grounding leg 24 is inserted therein.

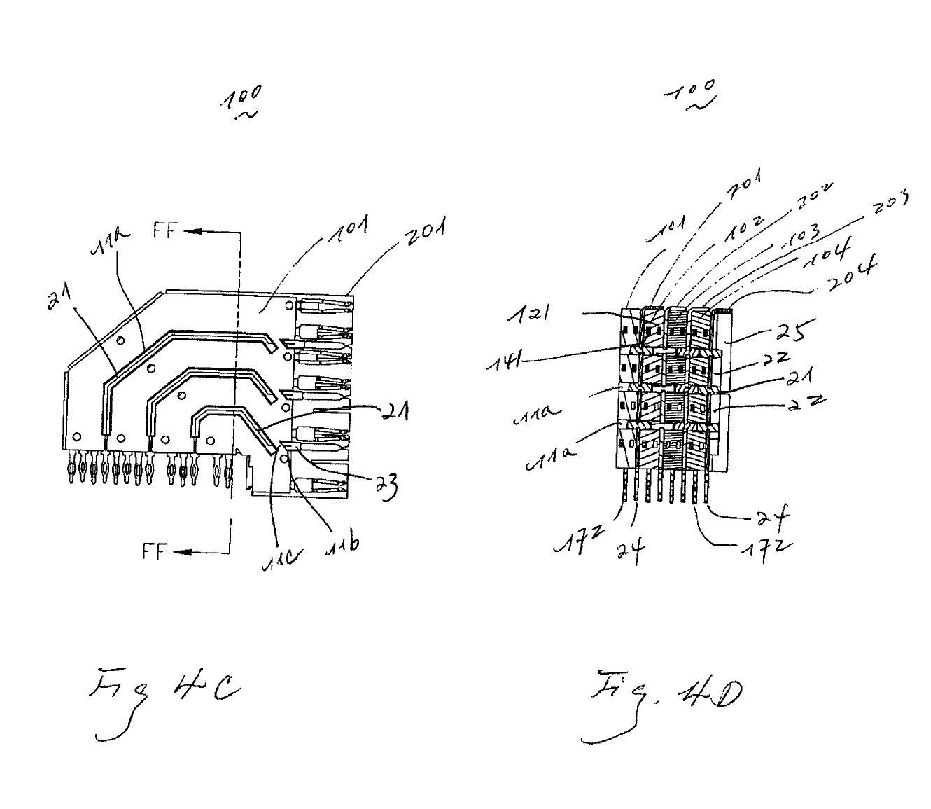

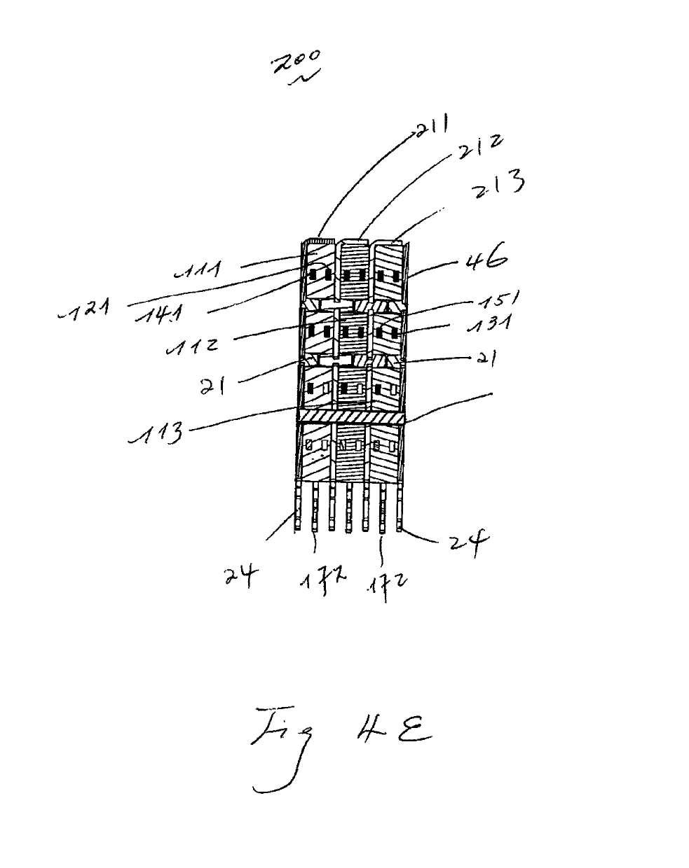

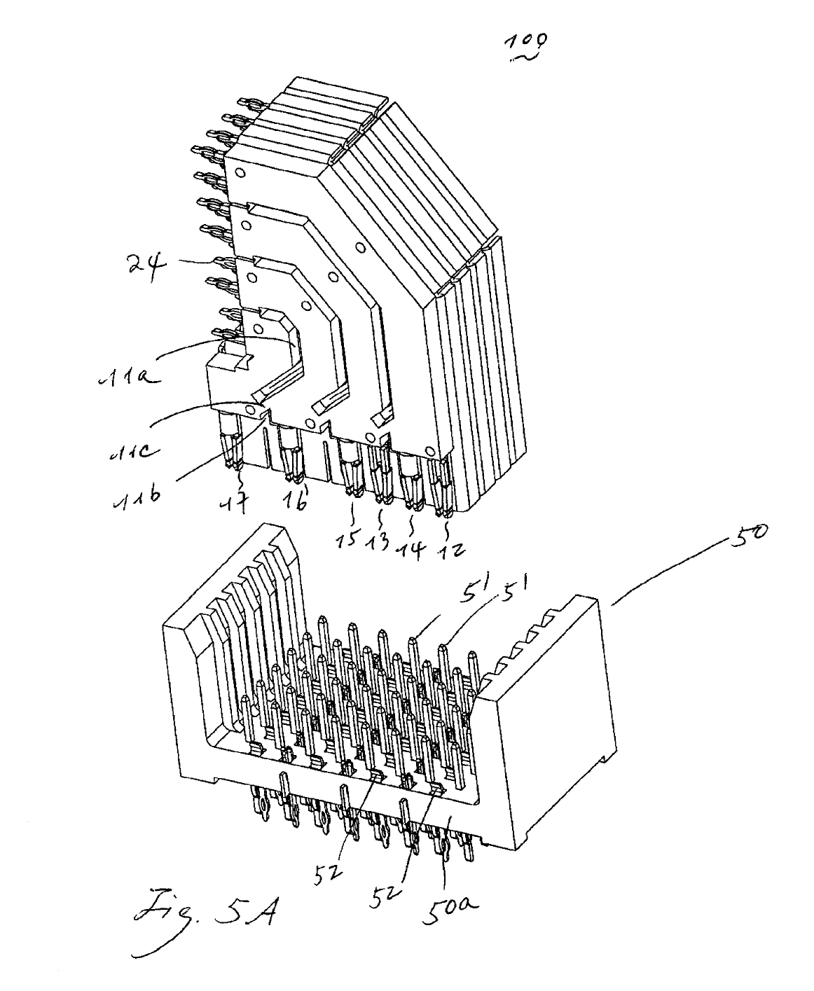

The grounding bus 20 further includes peripheral walls 25 which jointly define a receiving space 25 in which the wafer 10 can be snugly received therein, such as shown in FIG. 4D. By this arrangement, the wafer 10 is completely shielded by the corresponding grounding bus 20. In addition, as described above, the terminals 12, 13, 14, 15, 16, and 17 within the wafer 10

FIG. 2 is an assembled view of FIG. 1A. The arrangement shown in FIGS. 1A and 2 are just for easy understanding of the present invention. In the actual practice, the wafer 10 is completely enclosed the corresponding grounding bus 20.

FIG. 3A is a front view of FIG. 2, while FIG. 3B is a cross sectional view taken along line A-A of FIG. 3A. It can be readily seen from FIG. 3B, the base portions 121, 141, and 131, 151 are arranged in a side-by-side arrangement, thereby benefiting skew-free signal transmission.

FIGS. 4A to 4D disclose a high density connector 100 configured by four sets of wafers 101, 102, 103 and 104, and grounding buses 201, 202, 203, and 204 are stacked together to define a high density electrical connector 100. Since the wafers 101, 102, 103 and 104 are identical to wafer 10, no detailed description is given. In addition, similar elements are marked with same numeral references as wafer 10. The grounding buses 201, 202, 203 and 204 are also identical to grounding bus 20, no detailed description is given. Besides, similar elements bear the same numeral references as grounding bus 20.

FIGS. 4C is a front view of FIG. 4A, while FIG. 4D is a cross sectional view taken along line FF-FF of FIG. 4C. It can be readily seen that the wafers 102, 103 and 104 are enclosed by the corresponding grounding buses 201, 202, 203, and 204. In addition, the base portions 121, 141 of the terminals 12 and 14 are located within a passage 22 defined by the grounding bus 201 and the corresponding grounding ribs 21, for example. By this arrangement, the signal transmitted by the terminals 12 and 14 is completely shielded from noise. In addition, the terminals 12, 14 and 13, 15 are completely and electrically isolated by the grounding ribs 21 disposed therebetween. As a result, cross-talks between the terminal pairs 12, 14, and 13, 15 are completely eliminated.

FIG. 4E discloses another embodiment in accordance with the present invention. In this preferred embodiment, an electrical connector 200 configured by three wafers 111, 112, and 113 and the grounding buses 211, 212, and 213 are interlocked by a latch 40 which passes through the slots 20a of the grounding buses 211, 212, and 213, and the openings 11a of the wafers 111, 112, and 113 is disclosed. By this arrangement, all the wafers 111, 112, and 113, and the grounding buses 211, 212, and 213 are securely interlocked. In addition, an end plate 46 is attached to the outmost wafer 113 to completely and electrically enclosing the wafer 113 within the corresponding grounding bus 213. Accordingly, an electrical connector 300 configured by the wafers 111, 112, 113 grounding buses 211, 212, 213, and the end plate 46 is completely and electrically shielded.

FIG. 5A is a perspective view showing the connector 200 shown in FIG. 4A and a corresponding header 50 having an array of pin 51 extending therefrom.

The header 50 includes a base 50a with the pins 51 extending therefrom. The pins 51 are arranged in rows and every two adjacent rows of pins 51 are interposed with a row of grounding tabs 52. The pins 51 are to be mated with the mating portions 123, 133, 143, 153, 163, and 173 of the terminals 12, 13, 14, 15, 16 and 17, while the grounding tabs 52 are electrically mated with front tabs 20c of the grounding buses 201, 202, 203 and 204. Accordingly, when the connector 100 is mated with the header 50, all signal transmission is free from noise and EMI shielding.

FIG. 5B is a front view showing the mating of the connector 100 and the header 50. The doted line showing the connector 100 is mounted onto a first printed circuit board 60, while the header 50 is mounted onto a second printed circuit board 70. Generally, the second printed circuit board 70 is a motherboard, while the first printed circuit board 60 is a daughter board.

As clearly described above, the terminals 12 and 14 are equally and closely arranged in side-by-side arrangement, the terminals 12 and 14 can naturally serve as a differential pair to enhance signal transmission therethrough. The terminals 13 and 15 have the same advantages.

In addition, since the terminals 12 and 14 have almost the same contour, the impedance between the terminals 12 and 14 are actually equal.

In light of this, by the arrangement of the present invention, the terminals 12, 14, and 13, 15 can perfectly reach the requirements to serve as differential pair as well as matched impedance, while the prior art can never reach.

It should be noted that even the terminals 16, 17 are not incorporated with a counterpart terminals, such as terminals 12, 13, those counterpart terminals can be readily incorporated so as to serve as a differential pairs, such as terminals 12, 14; and 13, 15.

The wafer 10 (110) disclosed above includes only six terminals (12, 13, 14, 15, 16, 17 and 18), however, the terminals 17 and 18 can be also incorporated with additional terminals to construct a pair.

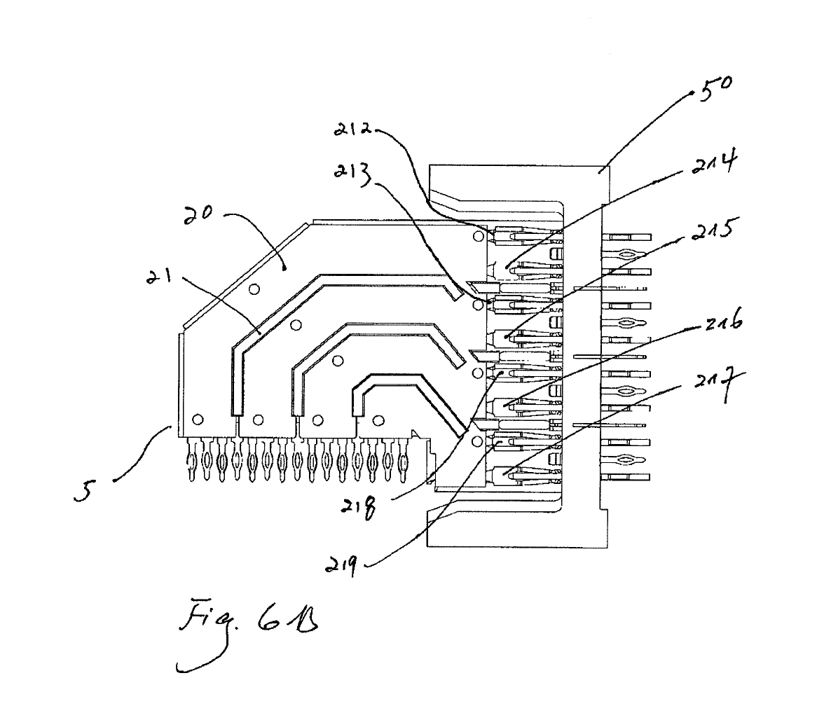

FIG. 6A discloses an electrical connector 5 which is configured by four wafers 210 each includes eight terminals 212, 213, 214, 215, 216, 217, 218, 219 and 220 in which terminals 212, 214 is a pair, while 213, 215 is a pair, 217, 219 is a pair, and 218, 220 is a pair.

FIG. 6B is a side view showing the electrical connector 5 is mated with a header 50 shown in FIG. 5A.

FIG. 6C is a front view showing that an electrical connector 7 in accordance with the present invention includes seven wafers 210 and seven grounding bus 20. It can be readily appreciated that each pair of terminals 212, 214; 213, 215; 216, 218; and 217, 219 are located in a channel defined by the grounding bus 20 and the grounding ribs 21. By this arrangement, the signal transmission is reliably ensured.

The connector 7 shown in FIG. 6C demonstrates one of the advantages of the present invention, i.e. the connector 7 can be easily expanded by additional wafers 210. Each wafer 210 and grounding bus 20 serves as an unit which can be selectively increased to configure an electrical connector according to the requirements. As a result, a plurality of connector can be easily derived from a single unit, the wafer 210 and the grounding bus 20. The manufacturing cost is therefore tremendously reduced.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. An electrical connector, comprising
a wafer integrally formed with a pair of terminal pairs and each pair configured by first and second terminals;
said first terminal including a first base portion having a first tail portion, and a first mating portion, said first tail and mating portions extending beyond said wafer;
said second terminal including a second base portion having a second tail portion, and a second mating portion, said second tail and mating portions extending beyond said wafer;
wherein said first and second base portions of said first and second terminal are spaced apart from each other in a side-by-side arrangement.

2. The electrical connector as recited in claim 1, wherein said wafer includes openings between said terminal pairs which is distant from each other.

3. The electrical connector as recited in claim 2, said electrical connector including a grounding bus having at least a grounding ribs extending into said opening defined between terminal pairs of said wafer.

4. The electrical connector as recited in claim 3, wherein said grounding bus includes peripheral walls defining a receiving space to receive said wafer therein.

5. An electrical connector, comprising
a wafer integrally formed with a pair of terminal pairs and each pair configured by first and second terminals,
said first terminal including a first base portion having a first tail portion, and a first mating portion, said first tail and mating portions extending beyond said wafer;
said second terminal including a second base portion having a second tail portion, and a second mating portion, said second tail and mating portions extending beyond said wafer;
a grounding bus attached to said wafer for providing EMI shielding.

6. The electrical connector as recited in claim 5, wherein said grounding bus includes at least a grounding ribs extending into an opening defined between terminal pairs of said wafer.

7. The electrical connector as recited in claim 5, wherein said grounding bus includes a plurality of pin legs.

8. An electrical connector, comprising
at least a pair of wafers integrally formed with a plurality of terminals therein, said each wafer defining at least an opening between two adjacent terminals;
a grounding bus located between said wafers and forming grounding ribs extending into said opening of said wafers.

9. The electrical connector as recited in claim 8, wherein said grounding bus includes peripheral walls defining a receiving space to receive at least one wafer therein.

10. The electrical connector as recited in claim 8, wherein said grounding rib extending from both faces of said grounding bus and into corresponding openings of said wafers.

11. The electrical connector as recited in claim 8, wherein said terminals include at least two pair of terminal pairs having first and second terminals, said first terminal including a first base portion and said second terminal including a second base portion having a side-by-side arrangement with respect to said first base portion.

12. The terminal connector as recited in claim 11, wherein said first and second base portions have equal length.

13. The electrical connector as recited in claim 8, wherein said grounding ribs and said grounding bus jointly defining a shielded passage in which said terminal extends therethrough.

14. The electrical connector as recited in claim 13, further including a second grounding bus enclosing said shielded passage together with said first grounding bus and grounding ribs of said first grounding bus.

15. The electrical connector as recited in claim 13, wherein said second grounding bus includes second grounding ribs extending to said openings of one of said wafer.

16. An electrical connector, comprising
at least a pair of wafers integrally formed with a plurality of terminals therein;
a first grounding bus located between said wafers; and
binding means between said wafers and said grounding bus for securely binding said wafers together.

17. The electrical connector as recited in claim 16, wherein said binding means includes grounding ribs formed on said grounding bus and openings defined in said wafers.

18. The electrical connector as recited in claim 16, wherein said wafer defines a plurality of undercut corresponding to said openings and separated therebetween with a bridge.

19. The electrical connector assembly as recited in claim 18, wherein said grounding buses further formed a plurality of short ribs distant to said grounding ribs and define a space for receiving said bridge therein.

20. An electrical connector, comprising
first and second wafers integrally formed with a plurality of terminals therein, said each wafer defining at least two openings adjacent to a terminal;
a first grounding bus located between said wafers and forming at least a pair of first grounding ribs extending into said openings of said first and second wafers; and
a second grounding bus attached to said first wafer such that said first wafer is sandwiched therebetween, said second grounding bus forming at least a pair of second grounding ribs extending into said openings of said first wafer.

21. An electrical connector assembly, comprising:
a receptacle connector configured by a plurality of wafers separated by grounding buses;
a header mated with said receptacle connector and including a plurality of pins for electrically connecting with sockets of said receptacle connector, and grounding tabs electrically mating with said grounding buses.

22. An electrical connector, comprising
a plurality of wafers integrally formed with a plurality of terminals therein;
a plurality of grounding bus arranged between said wafers; and
a latch extending through said wafers and said grounding bus for securely binding said wafers and said grounding buses together.

23. The electrical connector as recited in claim 22, wherein said wafers define a plurality openings and said grounding buses define a plurality slots aligned to said openings for receiving said latch therethrough.

24. The electrical connector as recited in claim 23, further including an end plate attached to an outmost wafer such that said wafer is sandwiched between said end plate and a corresponding grounding bus.

25. The electrical connector as recited in claim 24, wherein said grounding bus forms peripheral walls surrounding said wafer therebetween.

26. The electrical connector as recited in claim 24, wherein said end plate is securely engaged with said latch.

27. The electrical connector as recited in claim 22, wherein said grounding tabs of said header are alternatively arranged between pins of said header.

28. An electrical connector, comprising
a wafer integrally formed with a plurality terminals having at least of a pair of matched impedance terminals,
a grounding device dielectrically separating said matched impedance terminals with adjacent terminal.

29. An electrical connector, comprising
a wafer integrally formed with a plurality terminals having at least of a pair of differential terminal pair,
a grounding device dielectrically separating said differential terminal pair with adjacent terminal.

30. An arrangement of differential pairs of contacts, comprising:
a first terminals including a first base with a first mating portion and a first tail portion at two opposite ends thereof; and
a second terminals including a first base with a second mating portion and a second tail portion at two opposite ends thereof; wherein
the first base and the second base are spaced from and parallel to each other in a first direction and are of a similar dimension and configuration, while the first mating portion and the second mating portion are aligned with each other in a second direction perpendicular to said first direction, and the first tail portion and the second tail portion are aligned with each other in the second direction, whereby the first terminal and the second terminal form a differential pair for conductive transmission.

31. The arrangement as recited in claim 30,wherein the first mating portion and the second mating portion outwardly extend symmetrical with each other relative to a plane defined by the first base and the second base along said first direction.

32. The arrangement as recited in claim 30,wherein the first tail portion and the second tail portion outwardly extend symmetrical with each other relative to a plane defined by the first base and the second base along said first direction.

33. An arrangement of differential pairs of contacts, comprising:
a first terminals including a first base with a first mating portion and a first tail portion at two opposite ends thereof;
a second terminals including a first base with a second mating portion and a second tail portion at two opposite ends thereof;
the first base and the second base are spaced from and parallel to each other in a first direction and are of a similar dimension and configuration to form a differential pair thereof for conductive transmission; and
a grounding bus disposed by one side of said first terminal and said second terminal in a second direction perpendicular to said first direction for shielding said first base and said second base in said first direction; wherein
said grounding bus further includes a grounding rib extending in the first direction for shielding the first base and the second base in said second direction.

34. The arrangement as recited in claim 33, further including a third terminal and a fourth terminal arranged with a same pattern with the first terminal and the second terminal to form another differential pair, wherein said grounding rib extending between said two differential pairs.
